(19) United States
(12) Patent Application Publication
(10) Pub. No.: US 2003/0000973 A1
(43) Pub. Date: Jan. 2, 2003

(54) Pour spout

(76) Inventor: Hardy Martin, Dallas, TX (US)

Correspondence Address: DANIEL V THOMPSON, 12225 GREENVILLE AVENUE, SUITE 995, DALLAS, TX, 75243

(21) Appl. No.: 10/065,087

(22) Filed: Sep. 16, 2002

Related U.S. Application Data
(63) Continuation-in-part of application No. 09/619,810, filed on Jul. 21, 2000.
(60) Provisional application No. 60/188,837, filed on Mar. 13, 2000.

(51) Int. Cl. B67D 3/00

(52) U.S. Cl. 222/528

(57) ABSTRACT

A pour spout device is a unitary construction molded of flexible plastic, including a base cap and an elongated spout tube. The base cap has a lower section and an upper section joined at a lower shoulder section. The base cap lower section has an outer surface and a first set of threads formed on a first inner surface of the lower section. The base cap upper section has an outer surface and a second set of threads formed on a second inner surface. The first and second sets of threads have decreasing thread diameters, such that the first set of threads fits the opening of a bottle that is larger than a bottle that fits the second set of threads. The flexible plastic is a thermoplastic rubber having material characteristics such that the spout tube is flexible to bend and close by finger pressure, yet not take a set when repeatedly bent.

### CROSS REFERENCE TO RELATED APPLICATIONS

This application is a continuation in part of Ser. No. 09/619,810, filed Jul. 21, 2000, now abandoned, which was a non-provisional application based on provisional application Ser. No. 60/188,837, filed Mar. 13, 2000.

### BACKGROUND OF INVENTION

The present invention relates generally to pour spouts and funnels, and more particularly, is concerned with a pour spout having a base with multiple sized threads thereon permitting use with different size containers.

Devices for funnels have been described in the prior art. However, none of the prior art devices discloses the unique features of the present invention.

In U.S. Pat. No. 4,266,813, dated May 12, 1981, to Oliver, a coupler for joining tubes or garden hose female fittings to a receptacle is disclosed. It is primarily designed to transfer liquid in water holding tanks on RVs and yachts. Multiple base threads are provided to accommodate different sizes of receptacles. The tube/hose is a separate piece from the base, and is of indefinite length. The device is not a pour spout.

Tardiff disclosed in U.S. Pat. No. 5,370,279, issued Dec. 6, 1994, a squeeze canteen having a threaded cap and a flexible tube. The cap has only a single set of threads. The canteen is designed for dispensing consumable liquids.

In U.S. Pat. No. 4,453,653, issued Jun. 12, 1984 to Chapelsky, et al., a closure is provided for dispensers on ammonia hydroxide supplied to vapor-type diazo reproduction machines. The closure has dual collapsible spouts and a single set of threads.

In U.S. Pat. No. 5,927,353, dated Jul. 27, 1999, Persson, et al., disclosed a funnel for use in connection with reusable plastic bottles or containers which includes a body portion and a spout portion extending from the body portion to a lower open end. The spout portion is formed of downwardly extending inner and outer portions in spaced apart relation from one another to define a gap therebetween sized for receiving an upper portion of a fill spout of the plastic bottle. The outer portion has an interior surface facing the inner portion. A lower portion of the interior surface has an inwardly upwardly tapered portion adapted for receiving an outwardly extending portion of the fill spout in pressing engagement therewith to allow inward compression of the outwardly extending portion against the interior surface.

In U.S. Pat. No. Des. 404,979, dated Feb. 2, 1999, Harman, et al., disclosed the bottle-attaching funnel, as shown and described.

In U.S. Pat. No. 4,600,125, dated Jul. 15, 1986, Maynard, Jr. disclosed a convenient, spill-resistant and highly versatile pouring system for containerized liquids. A primary funnel includes a container seating well having a built-in container piercing element. The primary funnel is inverted and placed over a liquid container or vice versa to carry out the piercing operation, following which the primary funnel and pierced container are in an upright position so that the reduced diameter pouring spout of the primary funnel can enter an aperture of a receiver of the liquid. Easily attachable secondary and tertiary pouring spout extensions allow pouring from the primary funnel into receivers having restricted openings and into receivers at relatively inaccessible locations. A convenient closure plug adapted to fit all pouring spouts of the system is provided. The secondary pouring spout can also be conveniently coupled with a standard size outlet of a bulk liquid storage container.

In U.S. Pat. No. 5,758,804, dated Jun. 2, 1998, Wirth disclosed an improved clip-on pouring spout which is removably attachable to a screw neck of a container. The pouring spout has a funnel section with a mated prong pair extending proximally from a larger cross-sectional opening of the funnel. The prong pair together defines essentially an external perimeter of the neck. A lumen surface of the prong pair can have an interiorly extending rib, which provides an essentially tight connection when the prong pair is attached to the neck. The rib can extend from the lumen surface closer to an exterior and the interior surfaces of the funnel section. The clip-on pouring spout can have more than one prong pair, e.g., four prong pairs, with each prong pair sized to accommodate the same or differently sized screw necks. The pouring spout with a plurality of prong pairs can have an interiorly extending rib on each prong pair.

In U.S. Pat. No. 5,803,310, dated Sep. 8, 1998, Soon disclosed a bottle cap adaptable spout that is attachable to an appropriately modified plastic cap of a spent motor oil bottle that converts the spent motor oil bottle into an oiler for dispensing oil contained therein. The spout includes a bellow, elongated, slender, and cylindrically shaped spout tube, a hollow and generally conically-shaped nozzle that extends from one end of the hollow, elongated, slender, and cylindrically-shaped spout tube, a hollow, externally-threaded, and cylindrically-shaped spout tube, a first combination hexagonally-shaped spout tube, a first combination hexagonally-shaped nut and washer that threadably engages the hollow, externally-threaded, and cylindrically-shaped tube, externally to the plastic cap of the spent motor oil bottle, a second combination hexagonally-shaped nut and washer that threadably engages the hollow, externally threaded, and cylindrically-shaped tube internally to the plastic cap of the spent motor oil bottle, and a hollow, elongated, slender, and cylindrically-shaped pick-up tube that extends from one end of the hollow, externally threaded, and cylindrically-shaped tube and into the spent motor oil bottle, so that when the spent motor oil bottle is squeezed the oil contained therein is picked up by the hollow, elongated, slender, and cylindrically shaped pick-up tube and flows therethrough, through the hollow, externally-threaded, and cylindrically-shaped tube, through the hollow, elongated, slender, and cylindrically shaped spout tube, and through and out of the hollow and generally conically-shaped nozzle allowing the spent motor oil bottle to function as the oiler and selectively dispense the oil contained therein.

In U.S. Pat. No. 5,704,408, dated Jan. 6, 1998, Law disclosed a hollow tube attachable at one end to a container of fluid which is provided at the other end with a fluid conduit termination disk separated from the end of the hollow tube by a space that defines a fluid discharge opening. A slide valve on the exterior of the tube is biased into a closed position engaging the fluid conduit termination disk and precluding fluid transfer until the discharge opening is inside a receiving vessel. A barricade is disposed across the interior of the tube at an inclination relative to the longitudinal axis thereof. Formed through the barricade is at least one elongated aperture extending continuously from a first longitudinal position in the tube to a second longitudinal position in the tube that is located further from the container of fluid than is the first longitudinal position. When the slide valve is opened, fluid passes through the barrier at the first longitudinal position, while air is simultaneously exchanged therethrough at the second longitudinal position, venting the container of fluid.

In U.S. Pat. No. 5,419,378, dated May 30, 1995, Law disclosed a hollow tube attachable at one end to a container of fluid which is provided at the other end with an end cap in which is formed a fluid discharge opening through which to transfer fluid. The end cap includes a first portion inserted into the tube while a second portion remains exterior thereto. A slide valve on the exterior of the tube is biased into a closed position, precluding fluid transfer until the discharge opening is inside a receiving vessel. An air vent passageway in the form of an air vent recess in the outer surface of the first portion of the end cap communicates between the interior of the container and the exterior of the fluid conduit. When the receiving vessel is filled, fluid in the receiving vessel closes entry to the air vent passageway, terminating air flow into the container and stopping fluid flow through the conduit. Capillary sections of reduced cross-sectional area relative that of the air vent passage way are located at either end of the air vent recess. One is formed as an outer air vent aperture through the wall of the tube at the end of the air vent recess remote from the container the other is formed in the outer surface of the first portion of the end cap at the opposite end of the air vent recess.

U.S. Pat. No. 5,104,012, dated Apr. 14, 1992, McAllister, et al., disclosed a dispensing device for helping to pour the contents of a first container into a second container without spillage. The device includes a flexible tube having an opened end for being positioned on the pour spout of the first container, having an opened second end for being positioned adjacent the inlet opening of the second container, and having an opened interior extending between the opened first end and the opened second end for allowing the contents of the first container to be poured through the opened interior of the tube from the pour spout of the first container into the inlet opening of the second container. The device includes structure for securing the opened first end of the tube on the pour spout of the first container.

While these devices may be suitable for the purposes for which they were designed, they would not be as suitable for the purposes of the present invention, as hereinafter described.

### SUMMARY OF INVENTION

The present invention discloses a pour spout device having an elongated spout tube thereon attached to a base cap having multiple threaded connections so as to be attachable to containers having different thread sizes. The elongated spout tube is thin and pliable so as to be bendable and/or compressible with finger pressure thereby allowing the user to control the flow of fluids. It is expected that the present invention would come in various thread number and sizes and various spout sizes.

An object of the present invention is to provide a single piece spout for use with multiple containers. Another objective of the present invention is to provide a spout which can be controlled with finger pressure of the user. A further objective of the present invention is to provide a device which can be easily and cheaply manufactured.

The foregoing and other objects and advantages will appear from the description to follow. In the description reference is made to the accompanying drawings, which form a part hereof, and in which is shown by way of illustration specific embodiments in which the invention may be practiced. These embodiments will be described insufficient detail to enable those skilled in the art to practice the invention, and it is to be understood that other embod1ments may be util1zed and that structural changes may be made without departing from the scope of the invention. In the accompanying drawings, like reference characters designate the same or similar parts throughout the several views.

### BRIEF DESCRIPTION OF DRAWINGS

FIG. 1 is a side view of a pour spout of the present invention attached to a bottle.

FIG. 2 is a partial view of the invention in operation.

FIG. 3 is a side view of the invention.

FIG. 4 is a sectional view taken along lines 4-4 of FIG. 3.

FIG. 5 is a partial view of the invention in operation.

### DETAILED DESCRIPTION

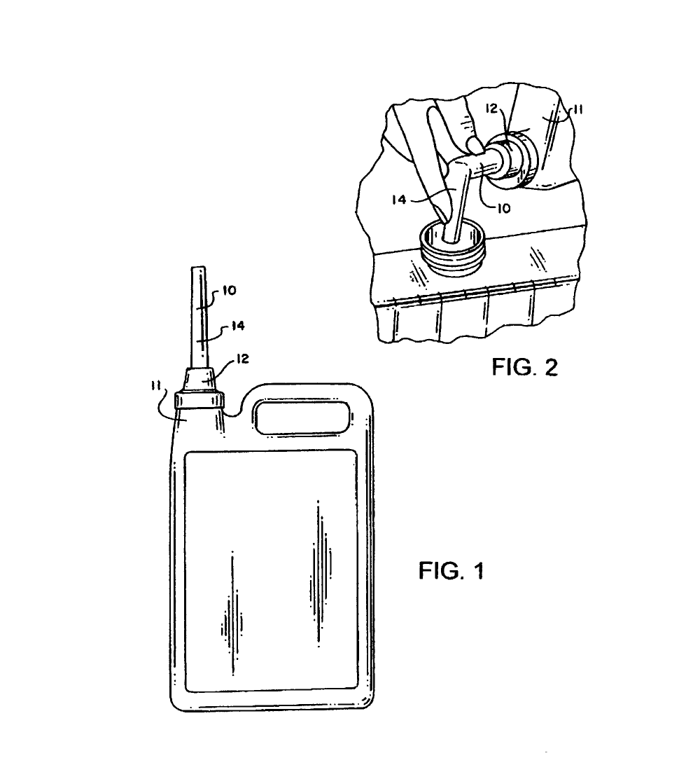

Referring initially to FIGS. 1 and 2, a pour spout 10 is attached to a bottle 11. Bottle 11 is illustrated as an automotive antifreeze container. In FIG. 2, antifreeze is being added to an automotive radiator. It is notoriously difficult to add antifreeze from a full bottle without spilling it, and antifreeze is a well-known environmental hazard as well as poisonous and attractive to dogs.

Pour spout 10 is a unitary construction molded of flexible plastic, including a base cap 12 and an elongated spout tube 14. An essential feature of the invention is that the flexible plastic is a thermoplastic rubber having material characteristics such that the spout tube is flexible to bend and close by finger pressure as shown in FIG. 2, such that pouring is initiated by merely letting the tube 14 straighten. Pour spout 10 is intended to be a relatively durable item, capable of repeated use. Thus, another essential material characteristic is that the thermoplastic rubber material not take a set, or dynamically fatigue, when repeatedly bent. In addition, the rubber needs to maintain its flexibility and fatigue resistance through a normal range of ambient temperature extremes. One example of the invention has been successfully molded of Santoprene ® 201-87 thermoplastic rubber, which has a Shore A hardness of 87.

A drawback of a suitably rubbery and flexible material, however, is that threads tend to expand when snugly interfitted with a threaded bottle top, causing leaks or misengagement of the threads. Thus careful attention must be paid to the structure of the thread base to which the pour spout is molded.

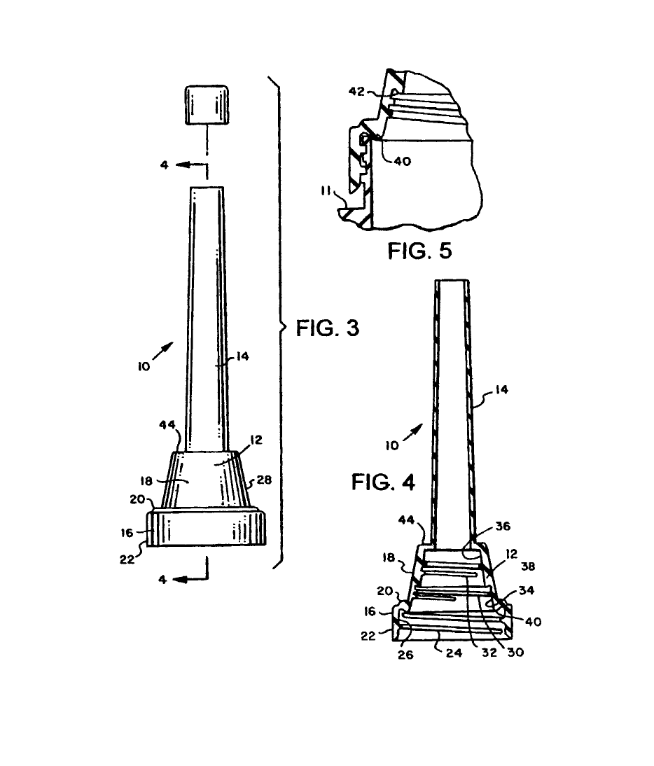

Referring now to FIGS. 3-5, the base cap 12 has a lower section 16 and an upper section 18 joined at a lower shoulder section 20. The base cap lower section 16 has a cylindrical outer surface 22 and a first set of threads 24 formed on a first inner surface 26 of the lower section 16. The base cap upper section 18 has a frustroconical outer surface 28 and second and third sets of threads 30,32 formed on second and third inner surfaces 34,36, respectively, thereof. The second and third inner surfaces 34,36 are joined at an upper shoulder section 38.

The first, second and third sets of threads 24,30,32 have decreasing thread diameters, such that the first set of threads 24 fits the opening of a bottle that is larger than a bottle that fits the second set of threads 30, and the second set of threads 30 fits the opening of a bottle that is larger than a bottle that fits the third set of threads 32.

As best shown in FIG. 5, the base cap lower shoulder section 20 including a first inner toroidal bead 40 for preventing the elastic expansion of the first set of threads 24 when a bottle 11 is snugly-threaded into the first set of threads 24. Bead 40 serves to lock the end of the bottle 11 opening between first inner surface 26 and bead 40, thereby preventing elastic expansion.

Similarly, the base cap upper shoulder section 38 includes a second inner toroidal bead for preventing the elastic expansion of the second set of threads 30 when a bottle (not shown) is snugly-threaded into the second set of threads 30.

The spout tube 14 extends from an annular section 44 at the top of the base cap upper section 18.

In operation, the device is molded from flexible thermoplastic rubber having a Shore A hardness of about 87, such that the spout tube is flexible to bend and close by finger pressure, yet not take a set when repeatedly bent.

1. A pour spout device, comprising:
a unitary construction molded of flexible plastic, including a base cap and an elongated spout tube;
the base cap having a lower section and an upper section joined at a lower shoulder section;
the base cap lower section having an outer surface and a first set of threads formed on a first inner surface of the lower section;
the base cap upper section having an outer surface and a second set of threads formed on a second inner surface;
the first and second sets of threads having decreasing thread diameters, such that the first set of threads fits the opening of a bottle that is larger than a bottle that fits the second set of threads;
the flexible plastic being a thermoplastic rubber having material characteristics such that the spout tube is flexible to bend and close by finger pressure, yet not take a set when repeatedly bent.

2. The device of claim 1 with second and third sets of threads formed on second and third inner surfaces, respectively, of the base cap upper section, and the second and third inner surfaces being joined at an upper shoulder section.

3. The device of claim 2 with the first, second and third sets of threads having decreasing thread diameters, such that the first set of threads fits the opening of a bottle that is larger than a bottle that fits the second set of threads, and the second set of threads fits the opening of a bottle that is larger than a bottle that fits the third set of threads

4. The device of claim 1 with the base cap lower shoulder section including an inner toroidal bead for preventing the elastic expansion of the first set of threads when a bottle is snugly-threaded into the first set of threads.

5. The device of claim 3 with the base cap upper shoulder section including an inner toroidal bead for preventing the elastic expansion of the second set of threads when a bottle is snugly-threaded into the second set of threads.

6. The device of claim 4 with the base cap upper shoulder section including an inner toroidal bead for preventing the elastic expansion of the second set of threads when a bottle is snugly-threaded into the second set of threads.

7. The device of claim 1 with the base cap lower section having a cylindrical outer surface and the base cap upper section having a frustroconical outer surface.

8. The device of claim 3 with the base cap lower section having a cylindrical outer surface and the base cap upper section having a frustroconical outer surface.

9. The device of claim 5 with the base cap lower section having a cylindrical outer surface and the base cap upper section having a frustroconical outer surface.

10. The device of claim 6 with the base cap lower section having a cylindrical outer surface and the base cap upper section having a frustroconical outer surface.

11. The device of claim 0 with the spout tube extending from an annular section at the top of the base cap upper section.

12. The device of claim 1 with the thermoplastic rubber having a Shore A hardness of about 87.

13. A pour spout device, comprising:
a unitary construction molded of flexible plastic, including a base cap and an elongated spout tube;
the base cap having a lower section and an upper section joined at a lower shoulder section;
the base cap lower section having a cylindrical outer surface and a first set of threads formed on a first inner surface of the lower section;
the base cap upper section having a frustroconical outer surface and second and third sets of threads formed on second and third inner surfaces, respectively, thereof, the second and third inner surfaces being joined at an upper shoulder section;
the first, second and third sets of threads having decreasing thread diameters, such that the first set of threads fits the opening of a bottle that is larger than a bottle that fits the second set of threads, and the second set of threads fits the opening of a bottle that is larger than a bottle that fits the third set of threads;
the base cap lower shoulder section including an inner toroidal bead for preventing the elastic expansion of the first set of threads when a bottle is snugly-threaded into the first set of threads;
the base cap upper shoulder section including an inner toroidal bead for preventing the elastic expansion of the second set of threads when a bottle is snugly-threaded into the second set of threads;
the spout tube extending from an annular section at the top of the base cap upper section;
the flexible plastic being a thermoplastic rubber having a Shore A hardness of about 87, such that the spout tube is flexible to bend and close by finger pressure, yet not take a set when repeatedly bent.
